(19) United States
(12) Patent Application Publication
(10) Pub. No.: US 2015/0150086 A1
(43) Pub. Date: May 28, 2015

(54) INTELLIGENT SELF-LOAD BALANCING WITH WEIGHTED PATHS

(71) Applicant: General Electric Company, Schenectady, NY (US)

(72) Inventor: Cullen Clark, Canaan, NH (US)

(73) Assignee: General Electric Company, Schenectady, NY (US)

(21) Appl. No.: 14/091,819

(22) Filed: Nov. 27, 2013

(51) Int. Cl. G06F 19/00; H04L 29/06; H04L 29/08; G06F 17/30

(52) U.S. Cl. CPC G06F 19/322; G06F 17/30864; H04L 63/08; G06F 19/321; H04L 67/1002
USPC 726/3; 705/3

(57) ABSTRACT

An example system to retrieve medical exams stored at a plurality of nodes includes a request receiver to receive a request for a plurality of medical exams via a first node of the plurality of nodes. Each node of the plurality of nodes is associated with a respective facility providing the medical exams. A load balancer is to determine a load generated on the first node based on the request and weigh the load on the first node relative to a load on at least a second node of the plurality of nodes. A path selector is to select a node of the plurality of nodes to process the request based on the weighted loads. Upon selection of the node, a query tool is to query the selected node and the plurality of nodes for the medical exams and deliver the medical exams to a user via the first node.

### RELATED APPLICATIONS

[Not Applicable]

### FEDERALLY SPONSORED RESEARCH OR DEVELOPMENT

[Not Applicable]

### MICROFICHE/COPYRIGHT REFERENCE

[Not Applicable]

### BACKGROUND

Healthcare environments, such as hospitals or clinics, include information systems, such as hospital information systems (HIS), radiology information systems (RIS), clinical information systems (CIS), and cardiovascular information systems (CVIS), and storage systems, such as picture archiving and communication systems (PACS), library information systems (LIS), and electronic medical records (EMR). Information stored may include patient medication orders, medical histories, imaging data, test results, diagnosis information, management information, and/or scheduling information, for example.

Medical exam results stored in, for example, the radiology information system associated with a hospital, require review by an examining radiologist. In reviewing an exam for a patient, the examining radiologist is often interested in prior exams conducted on the patient, such as exam data related to the exam presently under review with respect to body part, exam modality, and/or time frame. However, the patient's medical history often includes medical exams conducted at different healthcare facilities, including, for example, a hospital or a specialized clinic. Multiple data requests for prior exam data received at a healthcare facility from other facilities can burden the receiving facility's network resources and hamper the overall sharing of exam data between networked facilities.

### BRIEF SUMMARY

Certain examples provide methods, systems, and machine readable storage devices or storage discs for medical exam retrieval. Certain examples provide a system to retrieve medical exams stored at a plurality of nodes. The example system includes a request receiver to receive a request for a plurality of medical exams via a first node of the plurality of nodes. In the example system, each node of the plurality of nodes is associated with a respective facility providing the medical exams. The example system includes a load balancer to determine a load generated on the first node based on the request. In the example system, the load balancer is to weigh the load on the first node relative to a load on at least a second node of the plurality of nodes. The example system includes a path selector to select a node of the plurality of nodes to process the request based on the weighted loads. The example system includes a query tool. Upon selection of the node, the query tool is to query the selected node and the plurality of nodes for the medical exams. In the example system, the query tool is to deliver the medical exams to a user via the first node.

Certain examples provide a method to retrieve medical exams stored at a plurality of nodes. The example method includes receiving a request for a plurality of medical exams via a first node of the plurality of nodes. Each node of the plurality of nodes is associated with a respective facility providing the medical exams. The example method includes determining a load generated on the first node based on the request. The example method includes weighing the load on the first node relative to a load on at least a second node of the plurality of nodes. The example method includes selecting a node of the plurality of nodes to process the request based on the weighted loads. The example method includes querying the selected node and the plurality of nodes for the medical exams upon selection of the node and delivering the medical exams to a user via the first node.

Certain examples provide a storage device or storage disc containing instructions thereon, which, when read, cause a machine to at least receive a request for a plurality of medical exams via a first node of the plurality of nodes. Each node of the plurality of nodes is associated with a respective facility providing the medical exams. The example instructions cause the machine to at least determine a load generated on the first node based on the request. The example instructions cause the machine to weigh the load on the first node relative to a load on at least a second node of the plurality of nodes. The example instructions also cause the machine to select a node of the plurality of nodes to process the request based on the weighted loads. The example instructions cause the machine to query the selected node and the plurality of nodes for the medical exams upon selection of the node. The example instructions also cause the machine to deliver the medical exams to a user via the first node.

### BRIEF DESCRIPTION OF SEVERAL VIEWS OF THE DRAWINGS

FIG. 1 is a block diagram of an example medical exam distributor in an example healthcare system.

FIG. 2 is a block diagram of the example medical exam distributor of FIG. 1.

FIG. 3 depicts an example data-request processing relationship between nodes of a coalition associated with the example medical exam distributor of FIG. 1.

FIG. 4 depicts an example load-balancing relationship between nodes of the coalition of FIG. 3.

FIG. 5 is a flow diagram illustrating an example method for load balancing via the example medical exam distributor of FIGS. 1 and 2.

FIG. 6 is a flow diagram illustrating an example method for evaluating a load on a node associated with the example medical exam distributor of FIGS. 1 and 2.

FIG. 7 is a flow diagram illustrating an example method receiving an offloaded request from a node associated with the example medical exam distributor of FIGS. 1 and 2.

FIG. 8 is a flow diagram illustrating an example method for adding a new node to the coalition of FIGS. 3 and 4.

FIG. 9 shows a block diagram of an example processor system that may be used to implement systems and methods described herein.

The foregoing summary, as well as the following detailed description of certain examples of the present disclosure, will be better understood when read in conjunction with the appended drawings. For the purpose of illustrating the disclosure, certain examples are shown in the drawings. Wherever possible, the same reference numbers will be used throughout the drawing(s) and accompanying written description to refer to the same or like parts. It should be understood, however, that the present disclosure is not limited to the arrangements and instrumentality shown in the attached drawings.

### DETAILED DESCRIPTION OF CERTAIN EXAMPLES

Although the following discloses example methods, systems, and machine readable storage devices and storage discs including, among other components, software executed on hardware, it should be noted that such methods and apparatus are merely illustrative and should not be considered as limiting. For example, it is contemplated that any or all of these hardware and software components could be embodied exclusively in hardware, exclusively in software, exclusively in firmware, or in any combination of hardware, software, and/or firmware. Accordingly, while the following describes example methods, systems, and machine readable storage devices and storage discs, the examples provided are not the only way to implement such methods, systems, and machine readable storage devices and storage discs.

Also, although the methods, systems and machine readable storage mediums disclosed here are described in regards to healthcare applications, including, but not limited to, radiology information systems, it is to be understood that the present methods, systems and machine readable storage mediums may also be used to distribute information in any other industry/application.

A medical exam conducted on a patient can involve review by a healthcare practitioner, such as a radiologist, to obtain diagnostic information from the exam. In reviewing the exam, the radiologist is often interested in the patient's medical history, including prior exam results related to the exam presently under review. However, as the patient moves within a healthcare system, the patient often visits different healthcare facilities for treatment and thus, the patient's data is not centrally located at a single facility. Rather, each healthcare facility visited by the patient stores information about the patient and the patient's medical history, including the services delivered at the facility. Such stored data can include exams, such as, for example, x-rays or magnetic resonance imaging scans, and/or exam results. Thus, in a network of healthcare facilities, the patient's data is stored in decentralized manner across healthcare facilities.

A request by a reviewing radiologist at a first hospital to retrieve relevant prior exams and/or exam results associated with the patient from other healthcare facilities requires a search of a patient record database at each healthcare facility. As a member of a network of healthcare facilities, a facility can receive multiple requests from examining radiologists for relevant prior exam data associated with multiple patients. A request received at a server at a first facility can trigger the facility to reach out to search the servers of other facilities, aggregate the returned data, and deliver the aggregated data to the requesting client. Such operations create a load on the facility's server that can burden the facility's network resources and hamper the overall sharing of exam data between networked facilities. Because the network of healthcare facilities can include facilities of differing in size and resource availability (e.g., a small outpatient clinic verses a large research hospital), the ability of each facility in the network to handle the loads resulting from multiple data requests can vary.

Whereas known load balancing techniques may address multiple requests on a server, such techniques require additional and/or separate hardware resources. Further, known load balancing techniques do not account for decentralized storage of healthcare data between facilities that provides for a healthcare facility to enter and leave the network without concerns of data duplication, redundancy, and/or inappropriate access to personal health information.

Disclosed herein are example systems, methods, and storage devices and storage discs that provide for retrieval of relevant exams and/or exam data from multiple healthcare facilities in a network based on load-balancing of the data requests to the facilitates. The disclosed example systems, methods, and storage devices and storage discs can be used to facilitate review of an exam for a patient in view of the relevant prior exam data associated with the patient that was performed at a healthcare facility, whether that healthcare facility is the same facility where the practitioner is reviewing the exam or a different facility. Further, the examples disclosed herein include a load balancer determine an ability of a server at a facility receiving a request to query for locally and/or remotely stored exam to process the request in view the load created on the server by the request. The disclosed example load balancer is associated with each network server, thereby eliminating the need for a separate load balancer. Rather, in the examples disclosed herein, a respective load balancer is associated with each server in the network to dynamically assess a load on the respective server based on operational demands placed on the server. The network of load-balanced servers forms a coalition of nodes, with each node serving as an access point to receive and respond to requests for data associated with the respective healthcare facilities.

The disclosed example load balancer identifies a whether the server is capable of processing a newly received data request based on the server's available resources. In examples where the load balancer determines that the server is not capable of handling the load from a new data request, the load balancer identifies weighted paths to transfer the data request to another server in the coalition. In weighing the paths to each of the other servers in the coalition, the load balancer considers the available processing resources of each of the other servers in the coalition. The example load balancer selects a path that is associated with a server identified as more adequately capable of handling the request in view of processing capacity and facilitates transfer of the request to the selected server to promote efficiency and stability of the exam data-sharing network.

Examples disclosed herein also facilitate the dynamic and secure addition and/or removal of new facilities to the network or coalition of healthcare facilities. Upon joining the network, a new server is automatically recognized by the existing server in the network after being verified by an existing server. The new server is automatically integrated into the load-balanced network to share and access exam data within the network without requiring a transfer of data to a central storage point. The disclosed examples eliminate concerns of data duplication or redundancy and thereby protect the integrity of personal health information as facilities join or leave the network. In accommodating for decentralized storage of data, the examples disclosed herein provide a responsive, stable, and efficiency-driven approach to retrieving prior exam data in a network of multiple healthcare facilities.

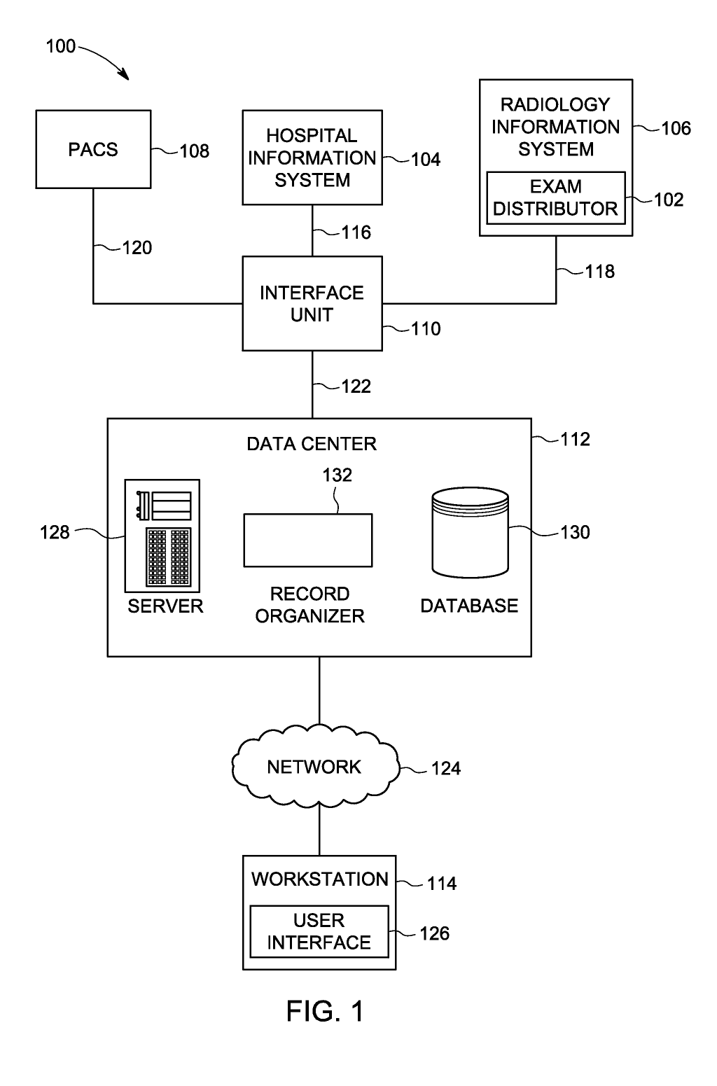

Turning now to the figures, FIG. 1 shows a block diagram of an example healthcare system 100 capable of implementing an example medical exam distributor 102. The example healthcare system 100 includes the example medical exam distributor 102, a hospital information system (HIS) 104, a radiology information system (RIS) 106, a picture archiving and communication system (PACS) 108, an interface unit 110, a data center 112, and a workstation 114. In the illustrated example, the HIS 104, the RIS 106, and the PACS 108 are housed in a healthcare facility and locally archived. However, in other implementations, the HIS 104, the RIS 106, and/or the PACS 108 can be housed one or more other suitable locations. In certain implementations, one or more of the PACS 108, RIS 106, HIS 104, etc., can be implemented remotely via a thin client and/or downloadable software solution. Furthermore, one or more components of the healthcare system 100 can be combined and/or implemented together. For example, the RIS 106 and/or the PACS 108 can be integrated with the HIS 104; the PACS 108 can be integrated with the RIS 106; and/or the three example information systems 104, 106, and/or 108 can be integrated together. In other example implementations, the healthcare system 100 includes a subset of the illustrated information systems 104, 106, and/or 108. For example, the healthcare system 100 can include only one or two of the HIS 104, the RIS 106, and/or the PACS 108. Information (e.g., scheduling, test results, exam image data, observations, diagnosis, etc.) can be entered into the HIS 104, the RIS 106, and/or the PACS 108 by healthcare practitioners (e.g., radiologists, physicians, and/or technicians) before and/or after patient examination.

The HIS 104 stores medical information such as clinical reports, patient information, and/or administrative information received from, for example, personnel at a hospital, clinic, and/or a physician's office. The RIS 106 stores information such as, for example, radiology reports, radiology exam image data, messages, warnings, alerts, patient scheduling information, patient demographic data, patient tracking information, and/or physician and patient status monitors. Additionally, the RIS 106 enables exam order entry (e.g., ordering an x-ray of a patient) and image and film tracking (e.g., tracking identities of one or more people that have checked out a film). In some examples, information in the RIS 106 is formatted according to the HL-7 (Health Level Seven) clinical communication protocol. In certain examples, the medical exam distributor 102 is located in the RIS 106 to facilitate distribution of radiology exams to a radiologist workload for review. In an alternative example, the exam distributor 102 can be located separately or can be included in any other suitable device of the healthcare system 100.

The PACS 108 stores medical images (e.g., x-rays, scans, three-dimensional renderings, etc.) as, for example, digital images in a database or registry. In some examples, the medical images are stored in the PACS 108 using the Digital Imaging and Communications in Medicine (“DICOM”) format. Images are stored in the PACS 108 by healthcare practitioners (e.g., imaging technicians, physicians, radiologists) after a medical imaging of a patient and/or are automatically transmitted from medical imaging devices to the PACS 108 for storage. In some examples, the PACS 108 can also include a display device and/or viewing workstation to enable a healthcare practitioner or provider to communicate with the PACS 108.

The interface unit 110 includes a hospital information system interface connection 116, a radiology information system interface connection 118, a PACS interface connection 120, and a data center interface connection 122. The interface unit 110 facilities communication among the HIS 104, the RIS 106, the PACS 108, and/or the data center 112. The interface connections 116, 118, 120, and 122 can be implemented by, for example, a Wide Area Network (“WAN”) such as a private network or the Internet. Accordingly, the interface unit 110 includes one or more communication components such as, for example, an Ethernet device, an asynchronous transfer mode (“ATM”) device, an 802.11 device, a DSL modem, a cable modem, a cellular modem, etc. In turn, the data center 112 communicates with the workstation 114, via a network 124, implemented at a plurality of locations (e.g., a hospital, clinic, doctor's office, other medical office, or terminal, etc.). The network 124 is implemented by, for example, the Internet, an intranet, a private network, a wired or wireless Local Area Network, and/or a wired or wireless Wide Area Network. In some examples, the interface unit 110 also includes a broker (e.g., a Mitra Imaging's PACS Broker) to allow medical information and medical images to be transmitted together and stored together.

The interface unit 110 receives images, medical reports, administrative information, exam workload distribution information, and/or other clinical information from the information systems 104, 106, 108 via the interface connections 116, 118, 120. If necessary (e.g., when different formats of the received information are incompatible), the interface unit 110 translates or reformats (e.g., into Structured Query Language (“SQL”) or standard text) the medical information, such as medical reports, to be properly stored at the data center 112. The reformatted medical information can be transmitted using a transmission protocol to enable different medical information to share common identification elements, such as a patient name or social security number. Next, the interface unit 110 transmits the medical information to the data center 112 via the data center interface connection 122. Finally, medical information is stored in the data center 112 in, for example, the DICOM format, which enables medical images and corresponding medical information to be transmitted and stored together.

The medical information is later viewable and easily retrievable at the workstation 114 (e.g., by their common identification element, such as a patient name or record number). The workstation 114 can be any equipment (e.g., a personal computer) capable of executing software that permits electronic data (e.g., medical reports) and/or electronic medical images (e.g., x-rays, ultrasounds, MRI scans, etc.) to be acquired, stored, or transmitted for viewing and operation. The workstation 114 receives commands and/or other input from a user via, for example, a keyboard, mouse, track ball, microphone, etc. The workstation 114 is capable of implementing a user interface 126 to enable a healthcare practitioner to interact with the healthcare system 100. For example, in response to a request from a physician, the user interface 126 presents a patient medical history. In other examples, a radiologist can retrieve and manage a workload of exams distributed for review to the radiologist by the medical exam distributor 102 via the user interface 126. In further examples, the radiologist can review exam images associated with the exams distributed by the exam distributor 102 via the user interface 126.

The example data center 112 of FIG. 1 is an archive to store information such as, for example, images, data, medical reports, and/or, more generally, patient medical records. In addition, the data center 112 can also serve as a central conduit to information located at other sources such as, for example, local archives, hospital information systems/radiology information systems (e.g., the HIS 104 and/or the RIS 106), or medical imaging/storage systems (e.g., the PACS 108 and/or connected imaging modalities). That is, the data center 112 can store links or indicators (e.g., identification numbers, patient names, or record numbers) to information. In the illustrated example, the data center 112 is managed by an application server provider (“ASP”) and is located in a centralized location that can be accessed by a plurality of systems and facilities (e.g., hospitals, clinics, doctor's offices, other medical offices, and/or terminals). In some examples, the data center 112 can be spatially distant from the HIS 104, the RIS 106, and/or the PACS 108 (e.g., at General Electric® headquarters).

The example data center 112 of FIG. 1 includes a server 128, a database 130, and a record organizer 132. The server 128 receives, processes, and conveys information to and from the components of the healthcare system 100. The database 130 stores the medical information described herein and provides access thereto. The example record organizer 132 of FIG. 1 manages patient medical histories, for example. The record organizer 132 can also assist in procedure scheduling, for example.

The example medical exam distributor 102 identifies a medical exam needing review and facilitates distribution of the exam to an examiner, such as a radiologist. The medical exam can be stored in the data center 112 or located in any other component of the healthcare system 100. An identifier associated with the medical exam distributed by the medical exam distributor 102 can be viewed by, for example, the radiologist to whom the exam has been distributed, other radiologists associated with the RIS 106, and/or a hospital administrator, via a viewer, such as the user interface 126 of the workstation 114. Further, the radiologist can access the exams (e.g., the images) distributed by the exam distributor 102 for reviewing and reporting via an image viewer associated with the user interface 126 (e.g., via the PACS 108).

As part of the exam distribution and review, the exam distributor also provides for the radiologist to access relevant prior exams and/or exam data associated with the distributed exam under review. In retrieving relevant prior exams, the exam distributor facilitates the searching and aggregating of exam data across the network of healthcare facilitates. Further, the exam distributor balances the loads placed on the servers at the respective healthcare facilities due to the requests for prior exam data. In such a manner, the exam distributor provides for efficient distribution and review of exams and relevant exam data across a network of healthcare facilitates.

In some examples, the exam distributor 102, and more generally, the hospital system 100, is associated with a facility that is a part of a coalition or network of healthcare facilities. As a member of the coalition, the facility shares medical information (e.g., patient history, exam results). In such examples, each healthcare facility that is part of a coalition includes the elements described in connection with the hospital system 100 of FIG. 1, including, for example, the exam distributor 102, the server 128, and record organizer 132, and/or the database 130. To facilitate sharing of data between the facilities of the coalition, a networked connection exists between the facilities such that each facility can be represented as a node in a fully connected network. Further, each node is aware of other nodes in the coalition for direct communication between the nodes. In such a manner, the hospital system 100 can communicate with other hospital systems 100 in a coalition, including, facilities of different sizes and/or services, such as hospitals, clinics, research institutions, etc.

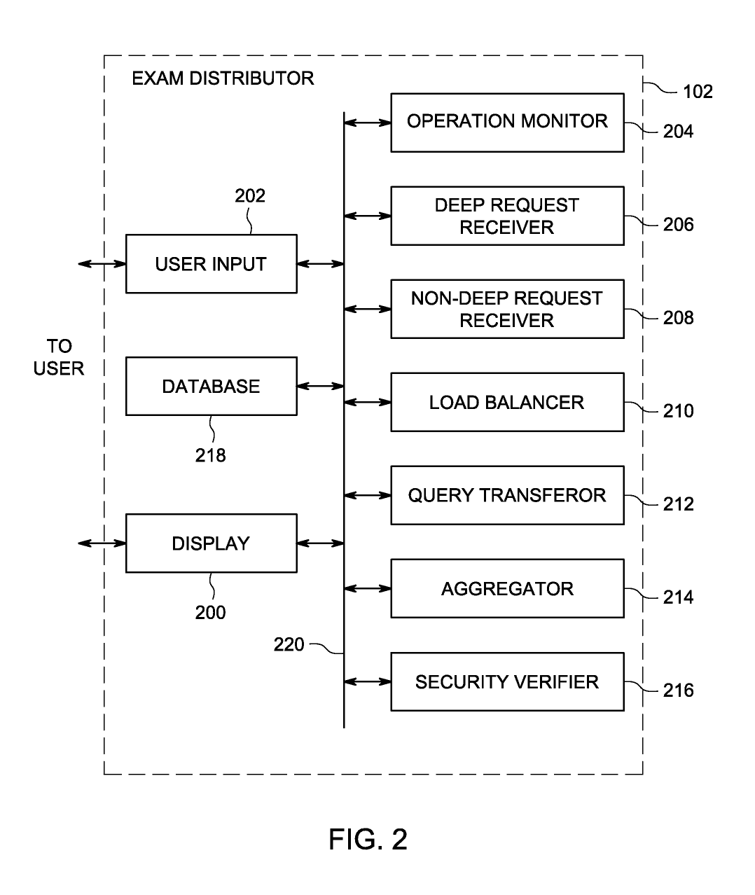

FIG. 2 shows a block diagram of the exam distributor 102 of FIG. 1 associated with a first facility (e.g., a first node in network) for retrieval of exam data from multiple facilities in a coalition. In some examples, the exam distributor 102 is associated with the radiology information system 106 to distribute and retrieve radiology exams and relevant prior exam data for review by a radiologist. The exam distributor 102 includes a display module 200, which may, for example, interact with the user interface 126 of the system 100 of FIG. 1. The radiologist can interact with the user interface 126 to view distributed exams and request and view prior exam data and/or results via the display module 200. The example exam distributor 102 also includes a user input module 202, which is to receive a user input from the user interface 126 to initiate, for example, a search for prior exam data.

The example exam distributor 102 includes an operation monitor 204. The operation monitor 204 continuously monitors one or more characteristics associated with the node of the coalition (e.g., the server 128). Example characteristics monitored by the operation monitor 204 include network latency, bandwidth, available processing resources (e.g., central processing unit (CPU) capacity, general processing unit (GPU), memory utilization, etc.), and a queue of requests received at the nodes.

As shown in the example of FIG. 2, the example exam distributor 102 includes a deep request receiver 206 and a non-deep request receiver 208. The deep request receiver 206 receives a request from a local client (e.g., the workstation 114) via a web service (e.g., the network 124) on the local server (e.g., the server 128). The deep request includes a request to query through every node associated with a healthcare facility affiliated with the coalition and to aggregate the returned data. For example, a radiologist accessing the workstation 114 at a first facility can send a request via the network 124 to a first node (e.g., the server 128) for all available prior exams associated with a patient, including those performed at other healthcare institutions. Such a request to the first node is a deep request. The first node searches locally for relevant data (e.g., data stored at the first server) and also sends out data requests to other nodes of the coalition.

The data requests sent out by the first node to the other nodes of the coalition direct the other nodes to query for locally stored data and to return any relevant data to the first node. Such requests sent to the other nodes of the coalition by the first node are non-deep requests, in that the other nodes of the coalition query for data stored at the server of the node receiving the request, but not query other nodes. For example,

For example, as described above, the first node receives a deep request from the workstation 114 for relevant prior exam data at other healthcare institutions. In response, the first node sends a non-deep request to the other nodes in the coalition, including a second node. The second node receives the non-deep request from the first node via the non-deep request receiver 208 associated with the second node. The second node searches locally for relevant data and returns the relevant data to the first node. As each node in the coalition can act as a local server and a remote server, each node in the coalition includes a deep request receiver 206 to receive local requests to search and aggregate data throughout the coalition as well as a non-deep request receiver 208 to receive requests for a local query initiated by a deep request at another node. Using the example above, when the second node receives a non-deep request via the non-deep request receiver 206, the second node performs a limited search of locally stored data and returns the data to the first node. If the second node receives a deep request via the deep request receiver 208 (e.g., from a workstation at the facility associated with the second node), the second node queries locally and also sends out non-deep requests to the other nodes in the coalition (including, for example, the first node). Thus, the nodes of the coalition receive and respond to local and remote data requests.

A deep request received via the deep request receiver 208 creates a load at the system where the request is received, as the system has to use resources to process the request, search locally, initiate non-deep requests at other nodes, and aggregate the resulting data. At the time the node receives the deep data request via the deep request receiver 206, the node is often performing other operations that also require resources and contribute to the load on the node, including, for example, responding to non-deep requests for exam data received from other systems via the non-deep request receiver 208, receiving patient medical records for storage, and distributing exams to radiologists. In some examples, the node may have insufficient resources at the time the deep request is received at the deep request receiver 208 to respond to the deep request without slowing down the operation of the node and/or sharing of data between the nodes of the coalition.

To evaluate the load on the system in response to the deep request, the example exam distributor 102 includes a load balancer 210. The load balancer 210 determines the load on the node based on the one or more characteristics of the deep requests and/or operation characteristics detected by the operating monitor 204. To determine the available resources of the node at the time the deep request is received, the example load balancer 210 considers the real-time CPU and/or other processor utilization, memory utilization, etc., by the node identified by the operation monitor 204. In some examples, to determine the load on the node, the load balancer 210 considers the queue of requests that have been previously received at the node and, therefore, can involve utilization of the node's available resources in responding to the request. The load balancer 210 compares the load to a predefined tolerable range to determine if the load is below, within, or above the range. For example, a load falling within the tolerable range indicates that the node is capable of processing the deep request in view of other demands on the load whereas a load that is above the range indicates that the node does not have enough resources to handle the deep request. The load balancer 210 dynamically determines the load on the node in view of new requests and/or demands on the node and automatically reevaluates the load to provide a real-time indication of the operational capabilities of the node.

In some examples, the load balancer 210 identifies the load on the node as above the acceptable tolerable range. In such examples, the load balancer 210 identifies a node in the network to offload or transfer the deep request to by considering characteristics such as network throughput, latency, and remote resource allocation. In particular, the example load balancer 210 determines the weight of a path of transferring the deep request to another node in the coalition. Using a predefined algorithm, the load balancer 210 determines the weight of a path to other nodes in the coalition based on values such as network latency, bandwidth, and CPU capacity. The algorithm provides a weighted value for each node of the coalition. The load balancer 210 compares the weighted value associated with each node to select a node to offload the deep request from the first node. In some examples, the load balancer 210 selects the node having the lightest weighted path based on predefined criteria. In such examples, the load balancer 210 identifies the selected node as having more available resources to process the deep request than the first node.

The example exam distributor 102 includes a query transferor 212. The query transferor 212 operates in response to the load identification by the load balancer 210. In some examples, the load balancer 210 determines that the load on the first system is below or within a threshold range. In such examples, the load balancer 210 determines that the first node has sufficient resources to process the deep request. The first node proceeds with processing the deep request by querying locally for any relevant prior exams and also sending a non-deep request to the other nodes in the coalition. In such examples, the query transferor 212 sends the non-deep request for exam data to each node in the coalition. In making the non-deep request, the query transferor 212 initiates each node within the coalition to perform a local search for relevant exam data stored at each node.

In other examples, the load balancer 210 determines the first node does not have sufficient resources to process the deep request based on the load generated by the deep request. The load balancer 210 identifies another available system to handle the deep request, based on for example, the comparison of weighted paths. In such examples, the query transferor 212 transfers the deep request to the node identified by the load balancer 210 as capable of handling the deep request. For example, the deep request is received from the query transferor 212 of the first node by the deep request receiver 206 associated with a second node in the coalition. In such examples, the query transferor 212 of the second node sends out non-deep requests to the nodes of the coalition, including the first node that initially received the deep request.

The example exam distributor also includes an aggregator 214. The aggregator 214 aggregates the data received by the nodes handling the deep request in response to queries performed by the nodes of the coalition. For example, if the first node handles the deep request, the aggregator 214 of the first node locally aggregates data retrieved from the first node as well as the data received from other nodes in response to the non-deep request initiated by the query transferor 212. As another example, if the deep request is transferred to the second node (e.g., based on a decision by the load balancer 210 of the first system), the aggregation of data is performed by the aggregator 214 of the second node. In such examples, the second node passes the aggregated to the first node (e.g., the system that initially received the deep request). The first node delivers the aggregated data to the requesting client. In some examples, the aggregated data is temporarily stored at the node the performed the aggregation and/or received the aggregated data. After delivering the aggregated data, the node that performed the aggregation removes the aggregated data and/or information associated therewith from, for example, the node's memory storage. Thus, concerns of data duplicity, accuracy, and/or inappropriate access to the aggregated exam data are reduced or eliminated and the node (and, thus, the healthcare facility with which the node is associated) can help maintain compliance with laws concerning the storage of personal health information.

The example exam distributor 102 also includes a security verifier 216. In the network of healthcare facilities, a healthcare facility can join or leave the coalition at will. Upon joining the coalition, the healthcare facility is treated as node in the coalition to which the other nodes can query for prior exam data stored at the newly joined node. Prior to the coalition accessing the data stored at the newly joined node, however, the security of the new node is verified by the security verifier 216 of an existing node in the coalition. The security verifier 216 confirms using authentication means that the node joining the network is in fact associated with a healthcare facility that is authorized to join the network. Upon verifying the authenticity of the new node via the security verifier 216, the existing node alerts other nodes in the coalition to existence of the new node. Each node in the coalition recognizes the new node and sends query requests for relevant exam data stored at the newly joined node.

The example exam distributor 102 also includes a database 218. The database 218 stores information concerning the operation statistics of the node. Further, the database 218 stores information concerning the recognition of other nodes in the coalition by the security verifier 216.

In the example shown, the components of the exam distributor 102, including the display module 200, the user input module 202, the operation monitor 204, the deep request receiver 206, the non-deep request receiver 208, the load balancer 210, the query transferor 212, the aggregator 214, the security verifier 216, and/or the database 218 are in communication with each other via a communications link 220. The communications link 220 can be any type of wired connection (e.g., a databus, a USB connection, etc.) and/or any type of wireless communication (e.g., radio frequency, infrared, etc.) using any past, present, or future communication protocol (e.g., Bluetooth™, USB 2.0, USB 3.0, etc.). Also, the components of the example exam distributor 102 can be integrated in one device or distributed over two or more devices.

While an example manner of implementing the exam distributor 102 of FIG. 1 is illustrated in FIG. 2, one or more of the elements, processes and/or devices illustrated in FIG. 2 may be combined, divided, re-arranged, omitted, eliminated and/or implemented in any other way. Further, the example display module 200, the user input module 202, the operation monitor 204, the deep request receiver 206, the non-deep request receiver 208, the load balancer 210, the query transferor 212, the aggregator 214, the security verifier 216, the database 218, and/or more generally, the example exam distributor of FIG. 1 may be implemented by hardware, software, firmware and/or any combination of hardware, software and/or firmware. Thus, for example, any of the example display module 200, the user input module 202, the operation monitor 204, the deep request receiver 206, the non-deep request receiver 208, the load balancer 210, the query transferor 212, the aggregator 214, the security verifier 216, the database 218, and/or, more generally, the example exam distributor 102 could be implemented by one or more analog or digital circuit(s), logic circuits, programmable processor(s), application specific integrated circuit(s) (ASIC(s)), programmable logic device(s) (PLD(s)) and/or field programmable logic device(s) (FPLD(s)). When reading any of the apparatus or system claims of this patent to cover a purely software and/or firmware implementation, at least one of the example display module 200, the user input module 202, the operation monitor 204, the deep request receiver 206, the non-deep request receiver 208, the load balancer 210, the query transferor 212, the aggregator 214, the security verifier 216, the database 218, and/or the example exam distributor 102 is/are hereby expressly defined to include a tangible computer readable storage device or storage disk such as a memory, a digital versatile disk (DVD), a compact disk (CD), a Blu-ray disk, etc. storing the software and/or firmware. Further still, the example exam distributor 102 of FIG. 1 may include one or more elements, processes and/or devices in addition to, or instead of, those illustrated in FIG. 2, and/or may include more than one of any or all of the illustrated elements, processes and devices.

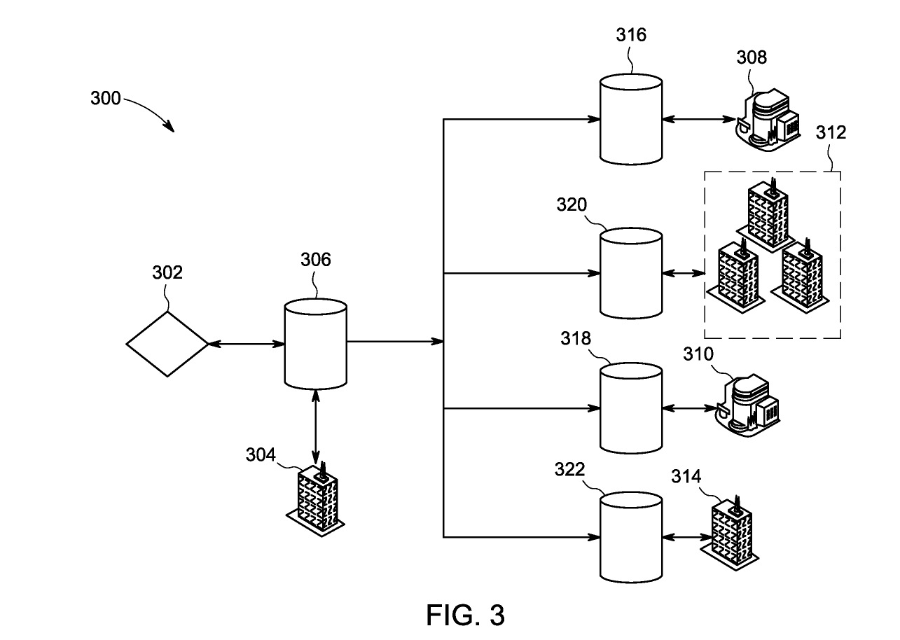

FIG. 3 shows an example data-request processing relationship 300 between an example coalition in response to a client 302 making a deep data request to a local node for relevant prior exam information stored at healthcare facilities in the coalition. In some examples, the client 302 is a radiologist workstation (e.g., the workstation 114) at a first facility 304. In FIG. 3, the first facility 304 is a small healthcare facility, such as a stand-alone clinic. A first node 306 of the first facility 304 stores patient data associated with patients who visit the clinic for services, including exams and tests. The first node 306 includes, for example, the server 128 of FIG. 1. A radiologist reviewing an exam for a patient at the workstation of the first facility 304 makes a deep request for relevant prior exam data related to the patient stored at the first facility 304 as well as other facilities in the coalition. The deep request is received by the first node 306 associated with the first facility 304 via, for example, the deep request receiver 206 of FIG. 2.

In the example coalition 300, the first facility 304 is communicatively associated with other healthcare facilities 308, 310, 312, 314 in the coalition. The other healthcare facilities include facilities of varying sizes and/or resources. In the example coalition 300, a second facility 308 and a third facility 310 are mid-size, stand-alone hospitals. A fourth facility 312 is a hospital group including multiple affiliated hospitals and healthcare facilities, such as outpatient clinics. A fifth facility 314 is a stand-alone clinic. The example coalition of FIG. 3 can include additional or fewer healthcare facilities. In the example coalition, each of the first through fifth facilities 306, 308, 310, 312, 314 can share data, receive deep requests, and send and/or receive non-deep requests.

Each of the second through fifth facilities 308, 310, 312, 314 is associated with a respective second through fifth node 316, 318, 320, 322 of the coalition 300. The nodes 316, 318, 320, 322 store data (e.g., medical records) for patients who receive services at the respective second through fifth facilities 308, 310, 312, 314, including data about exams conducted on patients at the facility. Thus, in the example coalition 300, there is the potential for each node 316, 318, 320, 322 to contain information that potentially is relevant to an exam being viewed by the radiologist at the first facility 304.

As described above in connection with FIG. 2, the first node 306 includes a load balancer (e.g., the load balancer 210). The load balancer 210 determines whether the first node 306 has sufficient resources to handle the load resulting from the deep request without hindering operation of the first node 306 and/or the coalition 300. In the example coalition 300 of FIG. 3, the load balancer 210 determined that the first node 306 has sufficient resources to process the deep request.

In responding to the deep request, the first node 306 searches locally for relevant exam data stored in, for example, the database 130 and/or the record center 132 of FIG. 1 associated with the first facility 304. The first node 306 also makes a non-deep request to each of the second through fifth nodes 316, 318, 320, 322. In making the non-deep request, the first server 306 facilitates searching of patient data collected at the second through fifth facilities 308, 310, 312, 314 for relevant data associated with the patient whose exam is under review by the radiologist at the first facility 304. The non-deep request is received by the non-deep request receiver 208 associated with each of the second through fifth nodes 316, 318, 320, 322.

Upon receiving the non-deep request, the second through fifth nodes 316, 318, 320, 322 perform a local query for relevant exam data. The second through fifth nodes 316, 318, 320, 322 query, for example, their respective databases 130 and/or the record centers 132, for relevant, locally-stored exam data. For example, if the patient had an exam performed the second facility 308 that is related to the exam under review by the radiologist at the first facility 304, the second node 316 retrieves the exam and/or the exam results. The second through fifth nodes 316, 318, 320, 322 return the relevant exam data, if any, to the first node 306.

The first node 306 aggregates the data returned from the second through fifth nodes 316, 318, 320, 322 and the data results from the local query of the first node 306. In some examples, the aggregation is performed by the aggregator 214 of the first node 306. The first node 306 returns the aggregated data to the client 302. The radiologist working at the client 302 can view the results of the search, including, for example, prior exam images and/or results, via the user interface 126 of FIG. 1.

As described, the example data-request processing relationship of FIG. 3 is implemented when the load balancer 210 associated with the first node 306 determines that the first node 306 has sufficient processing resources to handle the deep request received at the first node 306. However, in some examples, the load balancer 210 determines that the first node 306 does not have adequate resources to process the deep request due to the load placed on the first node 306 in response to the deep request and in view of other demands on the first node 306. The load balancer 210 also identifies a node of the coalition that is capable of processing the deep request.

For example, as part of the coalition, the first node 306 receives non-deep requests from one or more of the second through fifth nodes 316, 318, 320, 322 as a result of deep requests initiated via clients associated with the second through fifth nodes 316, 318, 320, 322 (e.g., radiologist viewing exams via workstations at the second through fifth facilities 308, 310, 312, 314) Thus, each time a deep request is made at one of the first through fifth nodes 306, 316, 318, 320, 322, the receiving node sends non-deep requests to each of the other nodes in the coalition. As a result, at any one time, the first node 306 can receive one or more deep requests as well as one or more non-deep requests. As an example, the first node 306 can receive a deep request from the client 302, a non-deep request from the second facility 308, and a non-deep request from the fourth facility 312 at substantially the same time.

Responding to the deep and the non-deep requests involves the first node 306 to use processing resources in querying for relevant prior exam data associated with the requests. In responding the non-deep requests, the first node 306 performs a local query of data stored in connection with the first facility 304 and returns the relevant data to the requesting node (e.g., the second and/or fourth nodes 308, 312). Responding to the deep request requires the first node 306 to perform a local query, send out non-deep requests to the other nodes, and aggregate the resulting data. Because, for example, the fourth node 320 is associated with the fourth facility 312 representing a group of hospitals, in some examples, the fourth node 320 returns a large amount of patient exam data in response to a non-deep request. Thus, sending out the non-deep requests and aggregating the resulting data can involve significant processing resources on the first node 306.

As the first node 306 is associated with a small clinic, in some examples, the first node 306 does not have sufficient processing capabilities to respond to a plurality number of deep and non-deep information requests that are substantially continuously delivered to the first node 306 as a member of the coalition. In such examples, the load balancer 210 detects that the load created on the first node 306 as a result of the deep request received via the client 302 is too high for the first node 306 in view of the current operational state of and demands on the first node 306.

The load balancer 210 identifies other nodes in the coalition that can handle the deep request based on operational characteristics of the other nodes. For example, whereas the first node 306 is associated with a small clinic (e.g., the first facility 304), the second node 310 is associated with a mid-size stand-alone hospital (e.g., the second facility 308) and may have increased capacity to process a deep request as compared to the first node 306. Also, the fourth node 320 is associated with a group of hospitals (e.g., the fourth facility 312, which may have increased processing capabilities as compared to the first node 306 and the second node 316. The load balancer 210 directs the deep request received at the first node 306 to a different node that has the capacity to process the deep request to efficiently respond to deep requests without overloading the first node 306 and hindering sharing of exam data within the coalition.

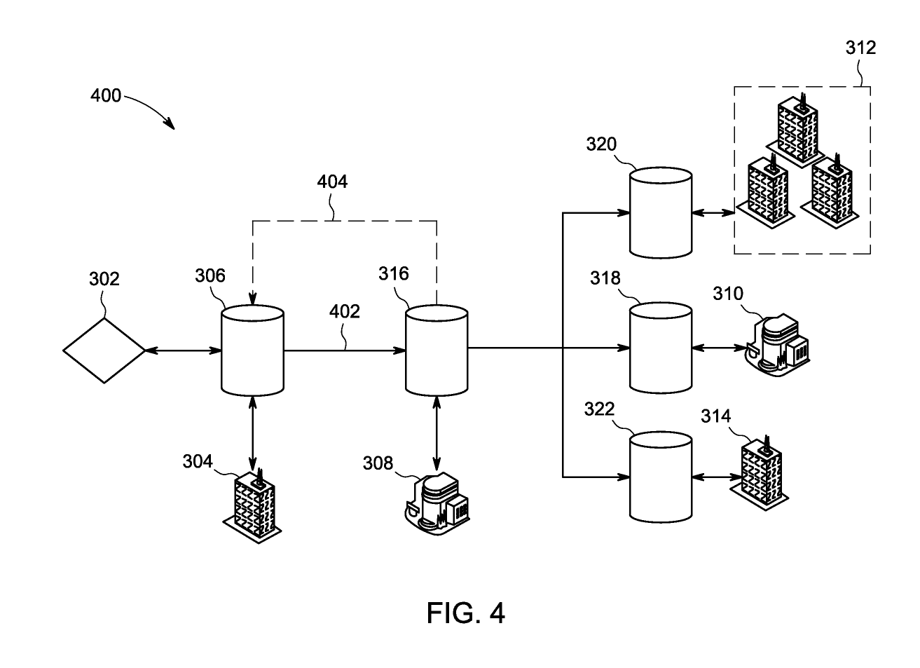

FIG. 4 is example load-balancing relationship 400 representing the offloading of deep requested delivered to the first node 306 to another node in the coalition. As described in connection with FIG. 3, the client 302 makes a deep request to the first node 306 of the first facility 304 for relevant prior exam data stored throughout the coalition of healthcare facilitates (e.g., the first through fifth facilities 304, 308, 310, 312, 314). In example load-balancing relationship 400 of FIG. 4, the load balancer 210 of the first node 306 determines based on one or more characteristics of the operational state of the first node and/or the deep request that the first node does not have sufficient resources to process the deep request. As a result, the first node 306 passes the deep request to one of the nodes in the coalition (e.g., the second through fifth nodes 316, 318, 320, 322) that has the capacity, based on real-time operational characteristics, to process the deep request.

In the example load-balancing relationship 400, the first node 306 passes the deep request to the second node 316 associated with the second facility 308, as represented by the arrow 402 of FIG. 4. In some examples, the query transferor 212 of the first node 306 facilitates the transfer of the deep request to the second node 316. The second node 316 processes the deep request by performing a local query for relevant exam data stored at the second node 316. The second node 316 also sends out non-deep requests to the first, third, fourth, and fifth nodes 306, 318, 320, 322. Because the first node 306 can contain relevant prior exam data, the first node 306 is still queried for data even though the first node 306 offloaded the deep request to the second node 316. As represented by the arrow 404 of FIG. 4, the second node 316 sends a non-deep request back to the first node 306 for exam data. In response to the non-deep requests, the first, third, fourth, and fifth nodes 306, 318, 320, 322 search locally for relevant exam data and return any relevant data to the second node 316.

In taking over the processing of the deep request from the first node 306, the second node 316 also handles the aggregation of the data returned from the node queries. The second node 316 returns the aggregated data to the first node 306 (e.g., as represented by the arrow 404). The first node 306 returns the aggregated data to the client 302.

In such a manner, the example load-balancing relationship 400 of FIG. 4 provides for offloading of a deep request to the first node 306 to a node that can more adequately handle the request in terms of processing capabilities. The example load-balancing relationship 400 promotes efficiency and stability of the coalition. In offloading the deep request, the first node 306 is relieved from sending out non-deep requests to every other node in the coalition and aggregating the returned data, both of which are expensive to the first node 306 in terms of resource utilization. By offloading the deep request, the first node 306 can continue to respond to non-deep requests and perform other operations without having comprising its stability and/or the stability of the coalition. Rather, the second node 316 accepts the load created by the deep request and handles the processing based on its increased processing capabilities relative to the first node 306. However, because the first node 306 can contain relevant exam data, the first node 306 is still queried for exam data, thereby ensuring that all relevant exam data is captured. Further, the aggregated data is returned to the first node 306 for delivery to the client 302, thereby resulting in no visible disruption or delay from the perspective of the user.

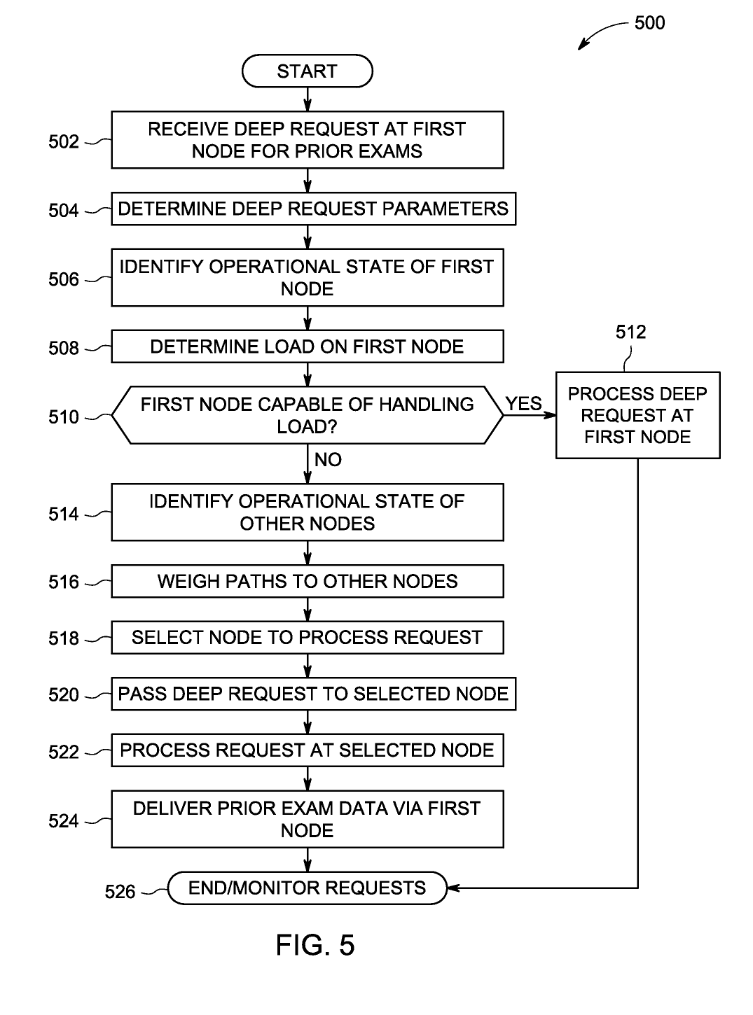

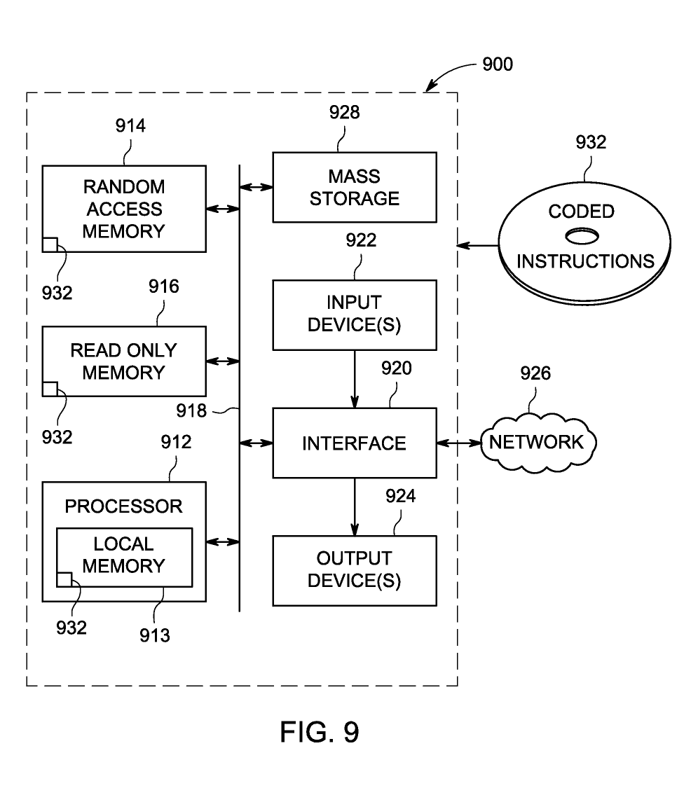

Flowcharts representative of example machine readable instructions for implementing the exam distributor 102 of FIG. 1 is shown in FIGS. 5-8. In this example, the machine readable instructions comprise a program for execution by a processor such as the processor 912 shown in the example processor platform 900 discussed below in connection with FIG. 9. The program may be embodied in software stored on a tangible computer readable storage medium such as a CD-ROM, a floppy disk, a hard drive, a digital versatile disk (DVD), a Blu-ray disk, or a memory associated with the processor 912, but the entire program and/or parts thereof could alternatively be executed by a device other than the processor 912 and/or embodied in firmware or dedicated hardware. Further, although the example program is described with reference to the flowchart illustrated in FIGS. 5-8, many other methods of implementing the example exam distributor 102 may alternatively be used. For example, the order of execution of the blocks may be changed, and/or some of the blocks described may be changed, eliminated, or combined.

As mentioned above, the example processes of FIGS. 5-8 may be implemented using coded instructions (e.g., computer and/or machine readable instructions) stored on a tangible computer readable storage medium such as a hard disk drive, a flash memory, a read-only memory (ROM), a compact disk (CD), a digital versatile disk (DVD), a cache, a random-access memory (RAM) and/or any other storage device or storage disk in which information is stored for any duration (e.g., for extended time periods, permanently, for brief instances, for temporarily buffering, and/or for caching of the information). As used herein, the term tangible computer readable storage medium is expressly defined to include any type of computer readable storage device and/or storage disk and to exclude propagating signals and to exclude transmission media. As used herein, “tangible computer readable storage medium” and “tangible machine readable storage medium” are used interchangeably. Additionally or alternatively, the example processes of FIGS. 5-8 may be implemented using coded instructions (e.g., computer and/or machine readable instructions) stored on a non-transitory computer and/or machine readable medium such as a hard disk drive, a flash memory, a read-only memory, a compact disk, a digital versatile disk, a cache, a random-access memory and/or any other storage device or storage disk in which information is stored for any duration (e.g., for extended time periods, permanently, for brief instances, for temporarily buffering, and/or for caching of the information). As used herein, the term non-transitory computer readable medium is expressly defined to include any type of computer readable storage device and/or storage disk and to exclude propagating signals and to exclude transmission media. As used herein, when the phrase “at least” is used as the transition term in a preamble of a claim, it is open-ended in the same manner as the term “comprising” is open ended.

FIG. 5 illustrates a flow diagram of an example method 500 for load-balancing by determining weighted paths and selecting a weighted path to process a deep request. The example method 500 can be implemented by the components of the exam distributor 102 described in connection with FIG. 2. The example method 500 begins at block 502 by the exam distributor 102 of a first node of a coalition of nodes (e.g., the first node 306 of the coalition of FIG. 3) associated with healthcare facilities (e.g., the first through fifth facilities 304, 308, 310, 312, 314) receiving a deep request. In some examples, the deep request is received via the deep request receiver 206 of FIG. 2.

Upon receiving the deep request, the example method 500 includes determining parameters and/or characteristics associated with the deep request (block 504). For example, characteristics such as patient identifying information, attributes associated with the exam under review and/or the requested exam data (e.g., body part, modality, priority level), requesting radiologist information, and/or time parameters of the requested information (e.g., exam data limited to a certain time frame) can be identified to determine the scope of the deep request.

The example method 500 also includes identifying the operational state of the first node receiving deep request (block 506). Identification of the operational state of the first node is performed by the operation monitor 204 of FIG. 2. For example, block 506 of the example method 500 includes identifying characteristics of the first node such as CPU utilization, memory utilization, and/or other pending deep requests and/or non-deep requests received at the first node, historical information associated with the processing of requests by the first node, and/or other demands related to the operation of the first node.

In view of the identified parameters of the deep request (block 504) and/or the operation state of the first node (block 506), the example method 500 includes determining a load on the first node. In some examples, the load is determined by the load balancer 210 of FIG. 2. The load on the first node represents, for example, the requests involving attention by the first node. As the load on the first node increases, the risk that the first node will be hampered or slowed in processing the requests increases. In some examples, the load created by the deep request and in view of other requests on the first node can cause an operational failure in the first node.

To prevent failure of the first node, the example method 500 includes a decision whether or not the first node is capable of handling the load created by the deep request (block 510). If the load balancer 210 determines that the first node is capable of handling the load, the example method 500 includes processing the deep request at the first node (block 512). For example, if the load balancer 210 determines that the load on the first node is below or within a tolerable range, the first node will accept the deep request and process the request as described in connection with the data request processing relationship 300 of FIG. 3.

In some examples, however, the load balancer 210 determines that the load on the first node is above a tolerable range. For example, as a result of one or more characteristics of the deep request and in view of the current operational state of the first node, the load balancer may determine that the first node does not have sufficient processing capacity to handle the deep request. In such examples, the deep request is offloaded from the first node to another node. To facilitate the off-loading of the deep request, the example method 500 selects an available node to transfer the deep request to for processing based on a comparison of loads as represented by weighted paths in the coalition. In weighing the paths for transferring the deep request from a first node to each of the other nodes in the coalition, the example method 500 identifies nodes that are not under a high load and considers the cost of transferring the deep request to the other nodes to compensate for the high load at the first node. Based on the cost evaluation, the example method 500 selects a node to receive the deep request from the first node.

As part of selecting a node to receive the offload deep request, the example method 500 includes identifying the operation state and available resources of other nodes in the coalition (block 514). In the example method 500, the first node is aware of the other nodes in the coalition as part of the data sharing between nodes (e.g., via the security verifier 216 of FIG. 2). Thus, the load balancer 210 does not need to search for other available nodes. Rather, at block 514, the load balancer identifies the real-time operational states of each of the other nodes in the coalition. For example, the bandwidth and processing capacity of the other nodes is identified as part of an evaluation of available nodes.

The example method 500 includes weighing the paths to each of the other nodes in the coalition to transfer the deep request (block 516). In some examples, the load balancer 210 employs an algorithm to weigh the paths. The algorithm considers, for example, operational status values for each of the other nodes identified at block 514, such as network latency, bandwidth, and/or processing resources, to obtain a weighted value associated with the path of transferring the deep request from the first node to the each of the other nodes in the coalition. In some examples, the weighted values obtained from the algorithm for each of the other nodes are compared relative to the node receiving the deep request and other nodes.

In the example method 500, a node is selected to process the deep request based on the weighing of the paths (block 518). In some examples, based on predefined criteria, the load balancer 210 identifies the path with the shortest or lightest weighted path and selects the node associated with that path to receive the transferred deep request. Other criteria for selecting a node may additionally and/or alternatively be used by the load balancer 210 in selecting a node to process the deep request. In some examples, although a second node has processing resources available to handle the deep request from the first node, as represented by the weighted path associated with the second node, the cost of transferring the deep request from the first node to the second node can be high in other respects. In some examples, the load balancer 210 considers the weighted paths in view of network resources.

For example, a node associated with a hospital in Illinois can receive a deep request, but have insufficient resources to handle the request. As part of the example method 500, a node associated with a hospital in Australia in the same network as the Illinois hospital can be identified as having CPU resources available to process the request as represented by, for example, the weighted path associated with the node of the Australian hospital. However, the load balancer 210 can decide not to offload the deep request onto the Australian hospital node because the time for that node to aggregate and return the data could hinder the operation of the network. For example, an amount of time for the aggregated data collected and processed at the Australian hospital node to be downloaded by the Illinois hospital node could consume excessive network resources (e.g., slow downloading time), despite the Australian hospital node having available resources to handle the deep request. In such examples, the load balancer 210 can select another node in the network based on the weighted paths to offload the deep request onto that also facilitates network efficiency. Thus, in selecting a node to receive the offloaded request, the example method 500 accounts for the weighted paths as well as the available resources to assess the costs of transferring the deep request from the perspectives of the node receiving the deep request locally, the node onto which the request is offloaded, and the network as a whole.

Upon selecting the node to process the deep request, the example method 500 includes passing the deep request to the selected node (block 520). In some examples, the query transferor 212 of FIG. 2 transfers the deep request to the selected node. Upon receiving the deep request, the selected node processes the deep request (block 522). For example, the selected node processes the deep request as described in connection with the load-balancing relationship 400 of FIG. 4 (e.g., sending non-deep requests to other nodes in the coalition and aggregating the returned data). After processing the deep request, the example method 500 includes delivering the prior exam data to the client via the first node (block 524). For example, the selected node returns the aggregated exam data to the first node. The first node delivers the aggregated to the client for viewing by the requesting radiologist. The example method 500 ends at block 526 with continuing monitoring of deep and non-deep requests at the nodes of the coalition.

In operation, the example method 500 provides for efficient load balancing of deep requests throughout a coalition of nodes by weighing paths associated with the transfer of a deep request from a receiving node to another node in the coalition. The example method 500 evaluates the load on the first node that receives the deep request to determine whether the first node has sufficient resources to process the deep request. In determining the load on the first node, the example method 500 accounts for characteristics associated with the deep request as well as other requests and/or demands on the first node to obtain a real-time indication of the ability of the first node to handle the deep request.

The example method 500 also identifies a node to receive the offloaded deep request. In identifying a node to receive the deep request, the example method 500 considers the costs of directing the deep request to another node in the network. In weighing the paths to transfer the deep request from the first node to each of the other nodes in the coalition, the example method 500 balances an incoming deep request with available resources throughout the coalition. The example method 500 directs the deep request to a node at minimal cost to the selected node as well as to the overall operation of the coalition. Further, the example method 500 increases stability of the first node that received the deep request yet has insufficient resources to handle the request by offloading the request without compromising the stability of the coalition. Also, in dynamically considering the operational state of each of the other nodes, the example method 500 recognizes that processing capabilities of each node vary based on real-time demands placed on the nodes. The example method 500 facilitates selection of the node that can efficiently process the deep request based on dynamic operational statistics for minimal disruption to the user's experience.

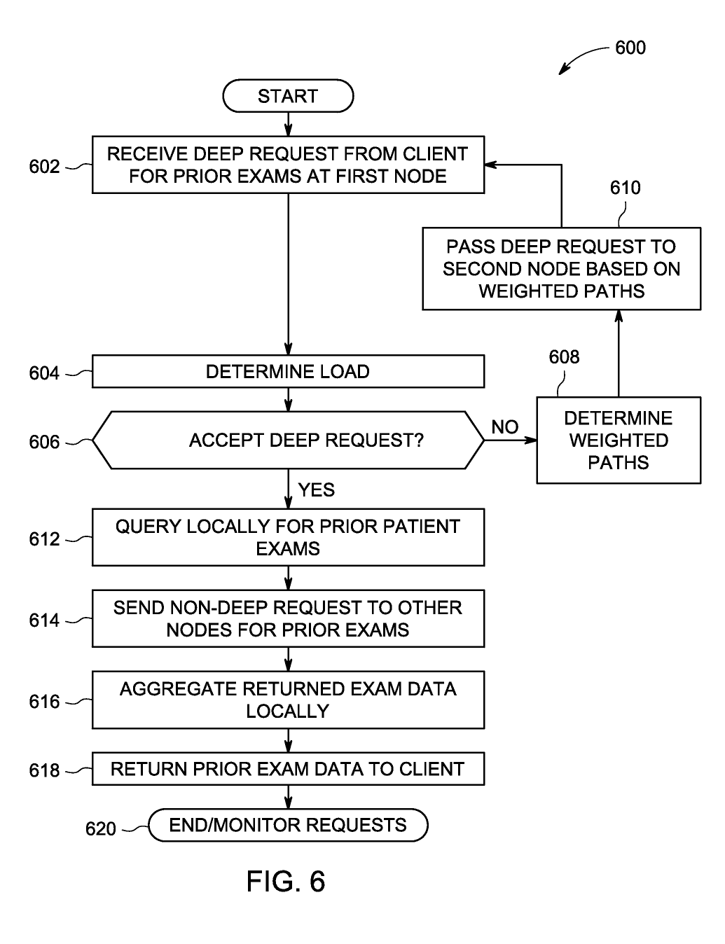

FIG. 6 illustrates a flow diagram of an example method 600 implemented by the load balancer 210 of FIG. 2 in determining whether a node (e.g., the first node 306 of the coalitions of FIGS. 3 and 4) should accept or pass a deep request received at the node. The example method 600 begins at block 602 with the first node receiving a deep request from a client (e.g., the client 302 of FIG. 3). For example, a radiologist at a workstation can make a request to view prior exam data associated with an exam under review. The first node receives the deep request via the deep request receiver 206 of FIG. 2.

At block 604, the example method 600 includes determining a load on the first node. The load balancer 210 of FIG. 2 determines the load by considering, for example, a real-time operational state of the first node as described in connection with the example method 500 of FIG. 5 (e.g., block 508). For example, the load balancer 210 detects other pending deep and non-deep requests received by the first node, characteristics of the newly received deep request, bandwidth and CPU capacity of the first node, as well other characteristics of and/or demands on the first node that impact the first node's available resources. The load balancer 210 considers a cost to the first node of processing the deep request, recognizing that responding to the deep request involves the first node reaching out to query every other node in the coalition and aggregate the returned data. In view of the deep request received at block 602, the load balancer 210 determines the current load on the first node.

Based on the load determined at block 604, the example method 600 includes a decision at block 606 whether or not to accept the deep request (e.g., process the deep request at the first node). For example, the load balancer 210 assesses the ability of the first node to process the first request in view of the load on the first node and the available resources of the first node. In some examples, the load balancer 210 determines whether the load identified at block 604 falls below, within, or above an acceptable, pre-defined range indicative of the tolerance of the first node in handling the load. The load balancer 210 considers the cost of processing the deep request at the first node with respect to the possibility the load could slow down the first node's operations and/or the operations of the coalition and/or result in an operational failure at the first node. In the example method 600, the load balancer 210 can implement one or more references, comparisons, and/or other approaches for evaluating whether the first node should accept the deep request. In some examples, a range of acceptable loads for a node can be adjusted for each node in the coalition based on resources available to the node, load tolerance, desired frequency of offloading, etc. For example, a user can set a high tolerable range for the first node such that the load balancer 210 only offloads the deep request if processing the deep request will cause the first node to fail.

If the load balancer 210 determines that the first node is not capable processing the deep request based on the load, the example method 600 includes the load balancer 210 weighing the paths to each of the other nodes in the coalition. In some examples, the load balancer weighs the paths to the other nodes as described in connection with the example method 500 of FIG. 5 (e.g., block 516). For example, the load balancer 210 considers operational values associated with the each of the other nodes in the coalition such as network latency, bandwidth, and available CPU resources to weigh the cost of passing the deep request to another node in the coalition.

At block 610, the example method 600 includes passing the deep request to a selected node (e.g., the second node 316 of FIGS. 3 and 4) based on the weighted paths. For example, the load balancer 210 compares the weighted paths to identify a node that is not under a high load and, thus, can process the deep request. In the example method 600, the load balancer 210 selects an example second node to receive the deep request. The deep request is passed to the second node via, for example, the query transferor 212 of FIG. 2, where the deep request is processed. The example method 600 continues with the first node receiving another deep request at block 602 and evaluating whether the first node can process the request in view of the load (e.g., blocks 604, 606).

Returning to block 606, if the load balancer 210 determines that the first node has sufficient available resources to process the deep request, the example method 600 proceeds to block 612, where the first node queries locally for prior patient exams and/or exam data. For example, the first node queries the server (e.g., the server 128 of FIG. 1) associated with the facility represented by the first node for relevant exam data based on the parameters of the deep request (e.g., patient information, exam attributes, time frame, etc.). The first node also sends non-deep requests to each of the other nodes in the coalition (block 614), thereby prompting the other nodes to search locally for exam data stored at the respective healthcare facilities. In some examples, the first node sends out the non-deep requests to the other nodes via the query transferor 212 of FIG. 2.

At block 616 of the example method 600, the first node aggregates the resulting data from the local search of the first node (block 612) and the data returned by the other nodes, if any, as result of the non-deep requests (block 616). In some examples, the aggregation of the data is performed by the aggregator 214 of FIG. 2. The first node returns the aggregated data to the requesting client (block 618). The examining radiologist can then view available relevant exam data for a patient collected across a network of healthcare facilities. At block 620, the example method 600 ends with continued monitoring of requests received at the first node.

In operation, the example method 600 provides for intelligent, built-in decision-making at the first node as to whether the first node is capable of handling a newly received deep request in view of real-time processing demands. In providing for a load-balancing assessment at the first node, the example method 600 dynamically considers the operational state of the first node. The example method 600 provides a node-specific evaluation as to whether the first node has sufficient resources to handle the resulting load associated with the deep request. Thus, the example method 600 considers the cost of processing the deep request to the first node. Such a node-based approach to load balancing accounts for the complexity of a coalition including many nodes and in which each node potentially stores relevant data. Rather than automatically processing a request and/or automatically passing a request to a node, the example method 600 determines the real-time risks of processing the node at the receiving node to both the receiving node and the coalition and balances the load associated with the deep request accordingly.

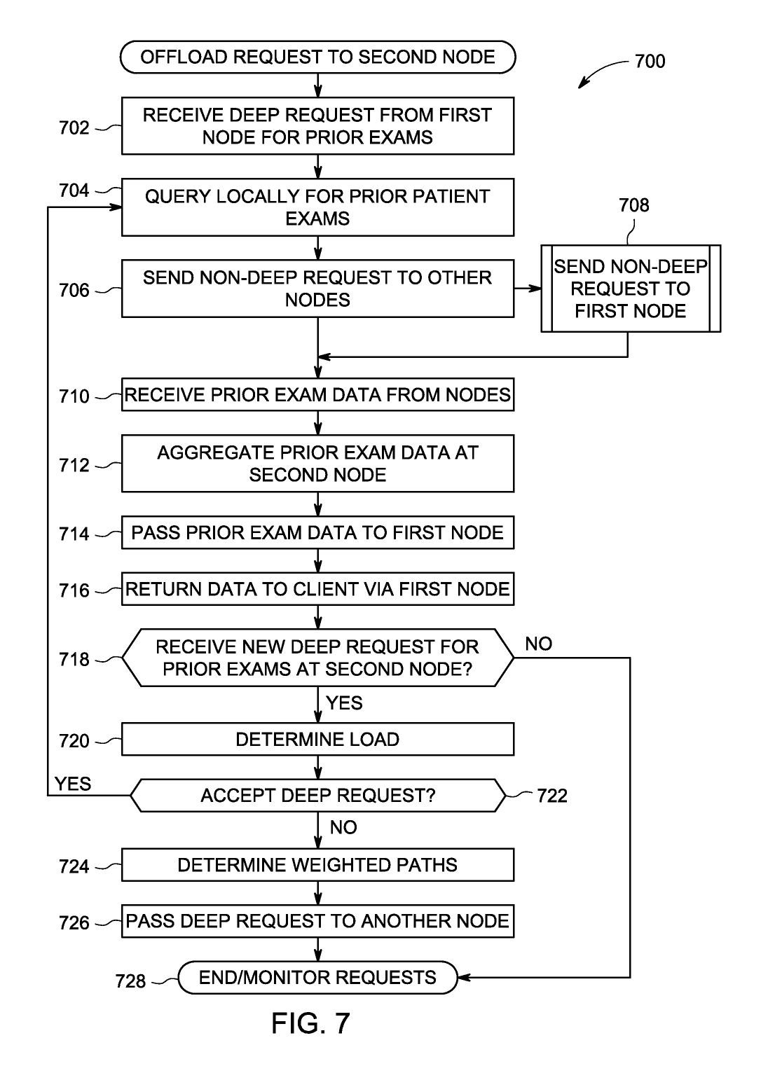

FIG. 7 illustrates a flow diagram of an example method 700 for processing a deep request offloaded from a first node to a second node (e.g., as represented by the arrow 402 of FIG. 4 from the first node 306 to the second node 316). The example method 700 begins at block 702 with the second node receiving the deep request for prior exam data from the first node. In some examples, the example method 700 is implemented in connection with the example method 600 of FIG. 6, such that a decision at blocks 606-610 (FIG. 6) to pass the deep request to the second node based on the evaluation of the load and the weighted paths triggers the implementation of the example method 700. In transferring the deep request to the second node, the second node has been identified, by, for example, the load balancer 210 of the first node, as having lesser load than the first node and thus, adequate resources to process the deep request. Thus, in the example method 700, the second node responds to the deep request.

As part of responding the deep request, the second node queries locally for prior patient exam data stored at the server (e.g., the server 128 of FIG. 1) of the healthcare facility with which the second node is associated (block 704). The second node also sends out non-deep requests to each of the other nodes in the coalition (block 706) via the query transferor 212 associated with the second node. The non-deep requests facilitate local querying at the other nodes for relevant prior exam data. As part of sending out the non-deep requests to the other nodes of the coalition, the second node sends a non-deep request to the first node from which the second node received the offloaded request (block 708). Although the load on the first node was determined to be too high for the first node to process the deep request, the first node can contain relevant prior exam data. For example, a patient may have visited the healthcare facility associated with the first node in the past for treatment. Thus, even though the first node offloaded the deep request to the second node, a query is performed at the first node to capture any relevant exam data stored at the first node.

In sending non-deep requests to the other nodes in the coalition, including the offloading first node, the example method 700 provides for the second node to receive relevant data from all nodes of the coalition (block 710). The example method 700 includes aggregating the returned prior exam data at the second (block 712). In some examples, the aggregator 214 of the second node performs the aggregation.

At block 714, the second node passes the aggregated prior exam data back to the first node (e.g., a represented by the arrow 404 of FIG. 4). Thus, in the example method 700, the second node performs the data querying (blocks 704-708) and the data aggregation (block 712) prior to passing the resulting data back to the first node. At block 716, the data collected in request to the deep request originally received at the first node is returned to the client via the first node.

As a member of the coalition of nodes representing networked healthcare facilities, the second node does not respond to the offloaded deep request in an isolated environment. Rather, the second node can receive other deep and/or non-deep requests at the same time or substantially the same time that the second node is processing the offloaded deep request. In the example method 700, a determination is made at block 718 whether the second node has received a new deep request for prior exams via, for example, the deep request receiver 206. In some examples, the deep request initiated from a client directly to the second node (e.g., via a workstation associated with the facility with which the second node is associated). The determination at block 718 can be made at any point during the example method 700, as the second node can continuously receive requests, including deep and/or non-deep requests, from clients and/or other nodes. For example, the determination at block 718 can be made substantially simultaneously as the second node processes the offloaded deep request (e.g., blocks 704-712). If a determination is made at block 718 that no new requests have been received by the second node, the example method ends with the second node monitoring requests (block 728).

If the determination is made at block 718 that the second node has receive a new deep request, for example, the example method 700 includes determining a load on the second node as a result of the deep request and in view of the other operational demands on the second node (block 720). For example, when the deep request is offloaded from the first node to the second node at block 702, the load on the second node increases, as the second node uses available resources to process the deep request. The second node has a higher load relative to load before receiving the offloaded deep request. Thus, in the example method 700, the load on the second node is dynamically identified at block 720 to reflect the current operational state of the second node. The load on the second node can be determined as described in connection with the examples methods 500 and 600 of FIGS. 5 and 6 (e.g., blocks 508, 604).

At block 722 of the example method 700, a determination is made whether or not the second node should accept the deep request or offload the deep request to another node in the coalition. In some examples, the second node is associated with a large healthcare facility (e.g., a university hospital) has networking capabilities equipped with, for example, a large bandwidth to handle many requests. In such examples, a determination can be made at block 722 that despite processing one or more deep requests and/or non-deep request, the load on the second node is such that the second node can handle another deep request. In such examples, the example method 700 proceeds with processing the deep request as described at, for example, blocks 704-716, with the second node, in some examples, acting as the first node (e.g., if deep request was received directly at the second node).

In other examples, because the second node is processing the offloaded deep request from the first node as well as, for example, non-deep requests from other nodes, the second node does not have adequate resources to process the deep requested received at block 718. For example, the second node can be associated with a small clinic or a mid-size hospital with limited network resources. When the determination was made in the example method 500 to select the second node to receive the offloaded deep request, the second node had adequate resources to process the deep request as compared to the first node and in view of a weighted comparison with other nodes in the coalition. However, in view of additional deep and/or non-deep requests received at the second node and/or other operational demands, the second node can presently have limited resources to respond to a new deep request. In such examples, a determination is made at block 718 for the second node to offload the new deep request to another node. In making the determination to offload the new deep request from the second node, the example method 700 proceeds with weighing paths for transferring the deep request to another node (block 724) and passing the deep request to a selected node having a lesser load (block 726) as described in connection with the example method 600 of FIG. 6 (e.g., blocks 608 and 610). The example method ends at block 728 with the second node monitoring requests.

In operation, the example method 700 provides for a second node in a coalition of nodes to accept an offloaded deep request that was originally received at a first node. The example method 700 provides for the second node to compensate for the high load at the first node by performing resource-expensive tasks of querying other nodes and aggregating the returned data before returning the relevant data to the first node for delivery to the client. In processing the offloaded deep request received from the first node, the example method 700 ensures that all relevant data is captured by directing the second node to send a non-deep request back to the first node. Thus, although the first node did not have sufficient resources to process the deep request, the first node is directed to query locally for relevant data related to the request. Thus, the example method 700 balances the load associated with the deep request by distributing resource-consuming tasks to the second node while capturing data at the first node via a non-deep request.

The example method 700 also recognizes the dynamic nature of the loads associated with nodes in the coalition as the nodes serve as access points to receiving and delivering data requests. In reevaluating capacity of the second node to process a new request in view of other requests and/or demands on the node, the example method 700 provides for ongoing load balancing and real-time adjustments to the distribution of deep requests throughout the coalition. Although the second node is capable of processing a deep request at a first time period, changing demands on the second node can result in an increased load on the second node such that the stability and the efficiency of the second node and/or the coalition would be better served by offloading the request to another node at a second time period occurring at substantially the same time or a later time than the first time period. In such a manner, the example method 700 provides for dynamic balancing of loads throughout a coalition of nodes associated with facilities of varying network resources.

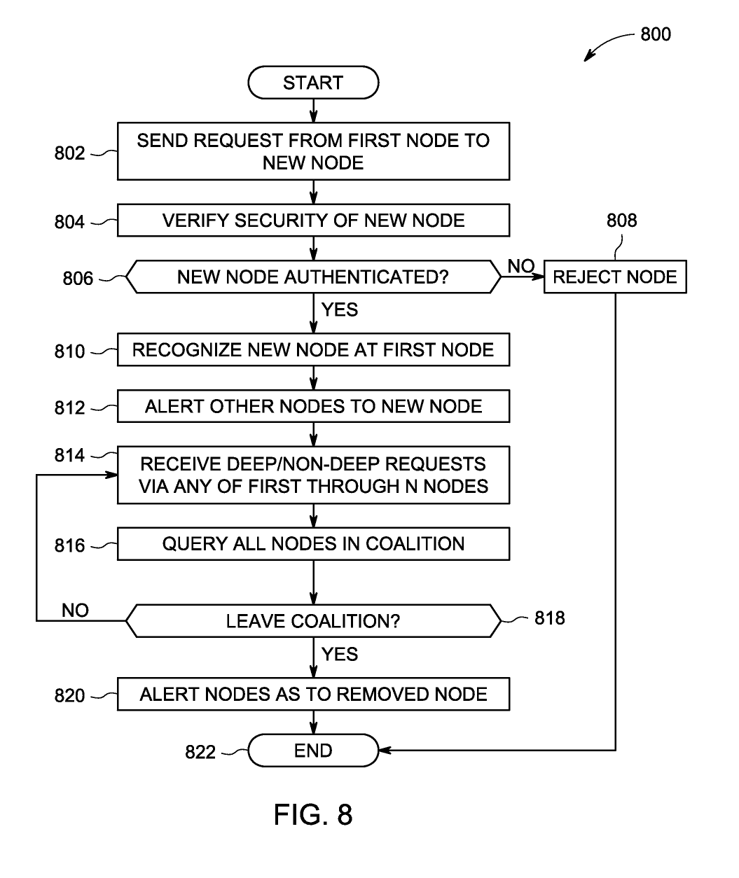

FIG. 8 illustrates a flow diagram of an example method 800 for adding new nodes to a coalition of existing nodes (e.g., the coalition depicted in FIGS. 3 and 4). For example, a healthcare facility can join a network of healthcare facilities as part of, for example, a data-sharing agreement, an affiliation with a hospital group or insurance provider, etc. The healthcare facility has stored data associated with patient medical history and treatment services performed at the facility. Thus, in networking with other healthcare facilities, the newly joining healthcare facility is a new access point represented by a node in the coalition that can receive, transfer, and respond to data requests. However, because of the sensitive nature of the healthcare data shared between the nodes and in view of protecting the integrity of the coalition, new nodes are added after undergoing a security verification process.

The example method 800 for adding a new node begins at block 802 with a first node associated with a healthcare facility in the coalition contacting a node that is not presently in the coalition. The node not presently in the coalition can be considered a new node relative to the existing nodes in the coalition (e.g., the new node can be associated with a healthcare facility joining the network). In some examples, the first node contacts the new node via a web service (e.g., the network 124). Upon establishing contact with the new node, the new node is verified via a security exchange between the first node and the new node (block 804). For example, a token (e.g., a unique ID) can be exchanged between the first node and the new node to verify that the new node should be joining the coalition and is affiliated with the appropriate facility that is expected to join the coalition In some examples, the security of the new node is verified using by the security verifier 216 of FIG. 2. In verifying the new node, the first node seeks to authenticate the node as a node that is permitted to access the coalition. For example, the first node seeks to establish a domain of trust between the first node and the new node such that the first node recognizes the new node as a valid access point in coalition.

The example method 800 includes a determination at block 806 whether or not the new node has been authenticated by the first node as a node that should be joining the coalition and that the node is associated with the appropriate facility. If the node seeking to join the coalition has not been authenticated by the first node, the node is rejected from connecting to the coalition and accessing the nodes of the coalition (block 808).

If a determination is made at block 806 that the new node is a verified node, the new node is considered within the domain of trust of the coalition. The example method 800 continues at block 810 with the first node recognizing the new node by, for example, adding the new node to a list of nodes recognized by the first node. The example method 800 includes alerting the other existing nodes to the presence of the new node as a verified member of the coalition (block 812). In the example method 800, requests by the new node are ignored by the existing nodes in the coalition until the exiting nodes receive notice that the new node is an authenticated node. For example, the first node sends out an updated list of authenticated nodes to the existing nodes, which can include the new node. In some examples, the first node sends out the list as part of sending out a request (e.g., a non-deep request) to the existing nodes in the coalition as part of receiving deep and/or non-deep requests in the course of receiving query requests via the healthcare facilities. In other examples, the first node pushes out the list of authenticated nodes to alert the existing nodes to the new node separately from sending a request.

Upon receiving the alert as to the existence of the new node, the other nodes in the coalition automatically identify the new node and treat the new node as any other node in the coalition. For example, the new node interacts with the coalition by receiving deep and/or non-deep requests via any of the first through n nodes of the coalition (block 814). The new node can also query all nodes in the coalition (block 816) by sending deep and/or non-deep data requests to the other nodes.

Thus, in the example method 800, the first node serves a gateway for the new node to join the coalition. In verifying and authenticating the new node via the first node and providing an initial push for recognition of the new node by other the nodes, the example method 800 provides for a resource-conservative approach to adding new nodes. Rather than all of the existing nodes in the network individually reaching out to and authenticating the new node as part of establishing the domain of trust with the new node, thereby using the processing resources of each of the nodes and taxing the operation of the coalition overall, the example first node performs the authentication process. As part of the fully connected network topology of the coalition, an alert from the first node to the other nodes as to the verified existence of the new node facilitates automatic sharing of data between the new node and the coalition. Also, because each node stores its own data, resources are not consumed in transferring data to a central location and/or the other nodes. Further, the risk of data duplication that can result from compiling data at a central location is eliminated. In such a manner, a new healthcare facility can join the coalition at will with minimal resource consumption and without comprising the security of the coalition.

The example method 800 also provides for a node to leave the coalition at will. In some examples, a healthcare facility ends its affiliation with a network of healthcare facilities based on for example, an end of a contractual agreement. At block 818, a decision is made whether or not a node leaves the coalition. If the node remains a member of the coalition, the example method 800 continues with the node receiving and responding to data requests (blocks 814-816). If, however, the node leaves the coalition, the node that has left the coalition alerts the other nodes that the other nodes of the coalition no longer have access to the data stored at the node that left (similarly, the node that left no longer has access to the data stored at the other nodes in the coalition). The node that has left the coalition alerts the remaining nodes to its removal from the coalition (block 820). In some examples, the removed node alerts the remaining nodes by pushing out a new list of authenticated nodes, which does not include the removed node. In other examples, the node that has left makes itself unavailable for receiving and/or responding to requests. In such examples, the node that has left is removed from the list of authenticated nodes by the coalition after a predefined period of time representing a timeout value for the node. Upon receiving the alert as to the removal of the node the remaining nodes automatically recognize that the node is longer available as an access point for retrieving data. At block 822, the example method 800 ends.

The example method 800 provides for efficient removal of a node from the coalition without concerns of compromising the security of the healthcare data and/or the stability of the coalition. Because each facility stores its own data, a node can leave the coalition without the need to remove the node's data from a central location and/or the other nodes, thereby minimizing the risk that personal health information is inappropriately accessed after the facility leaves. Further, when a node leaves the coalition, the remaining nodes are alerted, either through an active push of an updated authentication list or passively by the node making itself unavailable and being removed from recognition by coalition after a predefined timeout period. Upon receiving notice, the remaining nodes automatically recognize that the removed node is no longer available as an access point and stop sending data requests to that node. Thus, the example method 800 provides for secure, at-will addition and/or removal of node(s) associated with healthcare facilities from a coalition that accounts for the complexity of a network of healthcare facilities storing sensitive patient information, including prior exam data, in a decentralized configuration.

FIG. 9 is a block diagram of an example processor platform 1000 capable of executing the instructions of FIGS. 5-8 to implement the exam distributor 102 of FIG. 1. The processor platform 900 can be, for example, a server, a personal computer, a mobile device (e.g., a cell phone, a smart phone, a tablet such as an iPad™), a personal digital assistant (PDA), an Internet appliance, or any other type of computing device.

The processor platform 900 of the illustrated example includes a processor 912. The processor 912 of the illustrated example is hardware. For example, the processor 912 can be implemented by one or more integrated circuits, logic circuits, microprocessors or controllers from any desired family or manufacturer.

The processor 912 of the illustrated example includes a local memory 913 (e.g., a cache). The processor 912 of the illustrated example is in communication with a main memory including a volatile memory 914 and a non-volatile memory 916 via a bus 918. The volatile memory 914 may be implemented by Synchronous Dynamic Random Access Memory (SDRAM), Dynamic Random Access Memory (DRAM), RAMBUS Dynamic Random Access Memory (RDRAM) and/or any other type of random access memory device. The non-volatile memory 916 may be implemented by flash memory and/or any other desired type of memory device. Access to the main memory 914, 916 is controlled by a memory controller.

The processor platform 900 of the illustrated example also includes an interface circuit 920. The interface circuit 920 may be implemented by any type of interface standard, such as an Ethernet interface, a universal serial bus (USB), and/or a PCI express interface.

In the illustrated example, one or more input devices 922 are connected to the interface circuit 920. The input device(s) 922 permit(s) a user to enter data and commands into the processor 912. The input device(s) can be implemented by, for example, an audio sensor, a microphone, a camera (still or video), a keyboard, a button, a mouse, a touchscreen, a track-pad, a trackball, isopoint and/or a voice recognition system.

One or more output devices 924 are also connected to the interface circuit 920 of the illustrated example. The output devices 1024 can be implemented, for example, by display devices (e.g., a light emitting diode (LED), an organic light emitting diode (OLED), a liquid crystal display, a cathode ray tube display (CRT), a touchscreen, a tactile output device, a light emitting diode (LED), a printer and/or speakers). The interface circuit 920 of the illustrated example, thus, typically includes a graphics driver card, a graphics driver chip or a graphics driver processor.

The interface circuit 920 of the illustrated example also includes a communication device such as a transmitter, a receiver, a transceiver, a modem and/or network interface card to facilitate exchange of data with external machines (e.g., computing devices of any kind) via a network 926 (e.g., an Ethernet connection, a digital subscriber line (DSL), a telephone line, coaxial cable, a cellular telephone system, etc.).

The processor platform 900 of the illustrated example also includes one or more mass storage devices 928 for storing software and/or data. Examples of such mass storage devices 928 include floppy disk drives, hard drive disks, compact disk drives, Blu-ray disk drives, RAID systems, and digital versatile disk (DVD) drives.

The coded instructions 932 of FIGS. 5-8 may be stored in the mass storage device 928, in the volatile memory 914, in the non-volatile memory 916, and/or on a removable tangible computer readable storage medium such as a CD or DVD.

Although certain example methods, apparatus and articles of manufacture have been disclosed herein, the scope of coverage of this patent is not limited thereto. On the contrary, this patent covers all methods, apparatus and articles of manufacture fairly falling within the scope of the claims of this patent.

What is claimed is:

1. A system to retrieve medical exams stored at a plurality of nodes, the system comprising:
a request receiver to receive a request for a plurality of medical exams via a first node of the plurality of nodes, wherein each node of the plurality of nodes is associated with a respective facility providing the medical exams;
a load balancer to determine a load generated on the first node based on the request, wherein the load balancer is to weigh the load on the first node relative to a load on at least a second node of the plurality of nodes;
a path selector, wherein the path selector is to select a node of the plurality of nodes to process the request based on the weighted loads; and
a query tool, wherein upon selection of the node, the query tool is to query the selected node and the plurality of nodes for the medical exams, and wherein the query tool is to deliver the medical exams to a user via the first node.

2. The system of claim 1, further comprising an aggregator to aggregate the medical exams received from the query tool.

3. The system of claim 2, wherein the aggregator is to aggregate the medical exams at the selected node.

4. The system of claim 1, further comprising a security verifier to authenticate a node, wherein the query tool is to automatically query the node for the medical exams upon authentication.

5. The system of claim 1, further comprising an operational state identifier to identify at least one of a processing capability or a request queue of the first node and wherein the load balancer is to determine the load based on the identification.

6. The system of claim 1, wherein the load balancer is to dynamically weigh the load on the first node and the load on the second node based on a second request received at the second node.

7. The system of claim 1, wherein the query tool is to deliver the medical exams for viewing via an image viewer associated with the user accessing the first node.

8. The system of claim 1, wherein the load balancer comprises a respective load balancer associated with each node of the plurality of nodes.

9. A method to retrieve medical exams stored at a plurality of nodes, the method comprising:
receiving a request for a plurality of medical exams via a first node of the plurality of nodes, wherein each node of the plurality of nodes is associated with a respective facility providing the medical exams;
determining a load generated on the first node based on the request;
weighing the load on the first node relative to a load on at least a second node of the plurality of nodes;
selecting a node of the plurality of nodes to process the request based on the weighted loads;
querying the selected node and the plurality of nodes for the medical exams upon selection of the node; and
delivering the medical exams to a user via the first node.

10. The method of claim 9, aggregating the medical exams received from querying the selected node and the plurality of nodes.

11. The method of claim 10, further comprising aggregating the medical exams at the selected node.

12. The method of claim 9, further comprising:
authenticating a node; and
automatically querying the node for the medical exams upon authenticating the node.

13. The method of claim 9, further comprising:
identifying at least one of a processing capability or a request queue of the first node; and
determining the load based on the identification.

14. The method of claim 9, further comprising delivering the medical exams for viewing via an image viewer associated with the user accessing the first node.

15. A storage device or storage disc, containing instructions thereon, which when read cause a machine to at least:
receive a request for a plurality of medical exams via a first node of the plurality of nodes, wherein each node of the plurality of nodes is associated with a respective facility providing the medical exams;
determine a load generated on the first node based on the request;
weigh the load on the first node relative to a load on at least a second node of the plurality of nodes;
select a node of the plurality of nodes to process the request based on the weighted loads;
query the selected node and the plurality of nodes for the medical exams upon selection of the node; and
deliver the medical exams to a user via the first node.

16. The storage device or storage disc of claim 15, wherein the instructions cause the machine to aggregate the medical exams received from the query of the selected node and the plurality of nodes.

17. The storage device or storage disc of claim 16, wherein the instructions cause the machine to aggregate the medical exams at the selected node.

18. The storage device or storage disc of claim 15, wherein the instructions cause the machine to:
authenticate a node; and
automatically query the node for the medical exams upon the authentication.

19. The storage device or storage disc of claim 15, wherein the instructions cause the machine to:
identify at least one of a processing capability or a request queue of the first node; and
determine the load based on the identification.

20. The storage device or storage disc of claim 15, wherein the instructions cause the machine to deliver the medical exams for viewing via an image viewer associated with the user accessing the first node.
